(19) United States
(12) Patent Application Publication
(10) Pub. No.: US 2023/0182068 A1
(43) Pub. Date: Jun. 15, 2023

(54) Ammonia Removal in Contaminated Liquid and Gas Streams

(71) Applicant: Jiang Wan, Dupont, WA (US)

(72) Inventor: Jiang Wan, Dupont, WA (US)

(21) Appl. No.: 17/548,587

(22) Filed: Dec. 12, 2021

(51) Int. Cl. B01D 53/14

(52) U.S. Cl. CPC B01D 53/1493; B01D 2252/205; B01D 2257/406; B01D 2259/124

(57) ABSTRACT

Disclosed are compositions and methods of ammonia removal in contaminated liquid and gas streams. The compositions may comprise water-soluble phosphonium compounds that react selectively with ammonia at ambient conditions to form covalent compounds. For liquid-phase treatment, the water-soluble phosphonium compounds may be dosed into the contaminated streams followed by pH adjustment using pH elevating compounds to form insoluble compounds. For gas-phase treatment, the water-soluble phosphonium compounds may be used either as scrubbing solution or as solid adsorbent obtained by impregnation into solid substrates to form solid scavengers, to selectively absorb and react with ammonia in a scrubber system.

### FIELD OF THE INVENTION

This invention relates to compositions and methods of selective and fast ammonia removal in ammonia-contaminated liquid and gas streams.

### BACKGROUND

Ammonia-contaminated liquid and gas streams are generated by industrial sectors such as municipal wastewater treatments, landfills, petroleum refineries, and concentrated animal feeding operations. If discharged to the environment without treatment, these contaminated streams contribute to water and air pollution.

Ammonia in contaminated liquid streams is most commonly removed by the biological nutrient removal (BNR) process. The prior arts, for example, US EPA's Municipal Nutrient Removal Technologies Reference Document, Volume 1—Technical Report (EPA 832-R-08-006, September 2008); Biological Nutrient Removal (BNR) Operation in Wastewater Treatment Plants—MOP 29 (Water Environment Federation and the American Society of Civil Engineers. Alexandria, Va.: WEF Press), teaches that many configurations of BNR processes are practiced by the municipal wastewater treatment plant to remove ammonia. Biological processes are inherently slow and temperature-dependent, and therefore are expensive to build, maintain and operate. Less commonly, ammonia may be removed from the liquid stream by chemical and physical treatment. U.S. Pat. No. 8,939,676 (Eden, et al) and U.S. Pat. No. 10,266,423 (Theodoulou, et al) teach methods of air stripping at high pH to remove ammonia from contaminated liquid streams and recover free ammonia or ammonium sulfate solution as products.

Ammonia in contaminated gas streams may be removed by absorption in acid solutions or thermal destruction. U.S. Pat. No. 9,108,164 teaches a process to capture ammonia from an ammonia-contaminated gas stream using acid to form ammonium salt, but it is challenging to market or dispose of the byproducts. The methods of thermal destruction have the disadvantage of potentially creating secondary pollution problems.

Despite the existence of many prior arts for ammonia removal in the liquid and gas streams, there remains a need for treatment methods that overcome the limitations of prior arts.

### SUMMARY OF THE INVENTION

Accordingly, this invention discloses new compositions and methods of selective and fast ammonia removal in ammonia-contaminated liquid and gas streams. The invention is based on the newly discovered reaction between water-soluble phosphonium compounds and ammonia which lead to the formation of covalent compounds. The reaction may be carried out at ambient conditions with the reaction reaching completion in 10 minutes or less.

In accordance with one or more aspects, the disclosed compositions may be water-soluble tetrakis(hydroxymethyl) phosphonium (THP) salts of, including but are not limited to, borate, carboxylates, halides, sulfate, and sulfonates; wherein said carboxylates may be linear or branched; wherein said halides may include bromide, chloride, fluoride, and iodide; wherein said sulfonates may comprise linear or branched, monomeric or polymeric sulfonates

According to at least one embodiment, the THP salts may be concentrated or dilute aqueous solutions. THP salts may be dosed to liquid waste stream at a molar ratio to ammonia in the range of 1:1 and 1:2. The pH of the waste stream may be adjusted to a range between 5 and 11, more preferably between 5.5 and 10, most preferably between 6.5 and 9, using pH elevating compounds. The pH elevating compounds may be a water-soluble base, such as sodium hydroxide and potassium hydroxide. In yet another embodiment, the pH elevating compounds may be water-insoluble bases such as calcium hydroxide and magnesium hydroxide. In yet another embodiment, the water-soluble bases and water-insoluble bases may be combined for pH adjustment.

In accordance with one or more aspects, a gas stream contaminated with ammonia may be directed to come in contact with a concentrated or dilute aqueous solution of THP salts. The absorbed ammonia reacts with THP salts to form insoluble compounds when a certain threshold of pH is reached.

In accordance with one or more aspects, the THP salts may be impregnated into solid substrates to form solid scavengers. The solid substrates may comprise any chemically compatible substrates, including but are not limited to, zeolite, perlite, activated carbon, glass fiber, silica, clay, synthetic fibers, and biobased substrates. Solid scavengers may be packed in a packed-bed scrubbing system. The ammonia-contaminated gas stream may be passed through the packed-bed system for treatment.

### BRIEF DESCRIPTION OF THE DRAWINGS

FIG. 1 shows the reaction kinetics between ammonia and THP salt of chloride (THPC)

FIG. 2 shows dosing level of THPC affects the rate of ammonia removal

FIG. 3 depicts an apparatus that simulates ammonia stripping and capture with THPC solution

### DETAILED DESCRIPTION OF THE INVENTION

One or more embodiments relate generally to new compositions and methods of ammonia removal in contaminated liquid and gas streams. For illustration purposes, liquid streams and gas streams generated in wastewater treatment plants from the anaerobic digestion process are used as examples.

The municipal wastewater treatment plants (WWTP) represent one of the largest point sources of ammonia discharge. To meet the effluent limits for nitrogen nutrients, the technology of choice for WWTPs is predominantly the biological nutrient removal (BNR) process. The BNR processes are operated based on the key design criteria, solid retention time (SRT). SRT is typically maintained at 3-5 days for nitrification at summer temperature of 20° C. and doubled to 6-10 days at winter temperature of 10° C. Long SRT translates into a large reactor size, hence high capital cost.

In a typical WWTP, a side stream is generated from its anaerobic digestion process. This side stream contains high levels of ammonia-N, typically in the range of 600-1200 mg/l, which contributes to as much as 20-40% nitrogen load to the BNR process even though it only accounts for a fraction of the total plant flow. There has been considerable interest in the industry to treat side streams separately to reduce their impact on mainstream BNR. Several biological methods have been developed to treat side streams separately, but like mainstream BNR, these biological methods require long SRT.

The inventor has discovered a new ammonia treatment process that is substantially faster than the biological treatment process. One or more embodiments relate generally to the reaction between ammonia and water-soluble phosphonium salts. The water-soluble phosphonium may be tetrakis(hydroxymethyl)phosphonium (THP) salts of, including but not limited to, borate, carboxylates, halides, sulfate, and sulfonates; wherein said carboxylates may be linear or branched; wherein said halides may include bromide, chloride, fluoride, and iodide; wherein said sulfonates may comprise linear or branched, monomeric or polymeric sulfonates. For example, tetrakis(hydroxymethyl) phosphonium chloride (THPC) and tetrakis(hydroxymethyl) phosphonium sulfate (THPS) are commercially available in concentrated form as 80% aqueous solution. The concentrated form may be used with or without dilution.

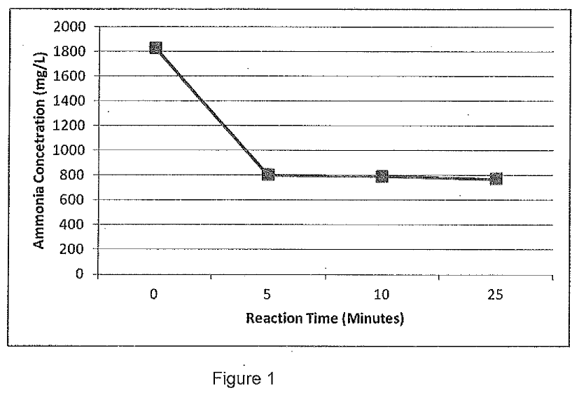

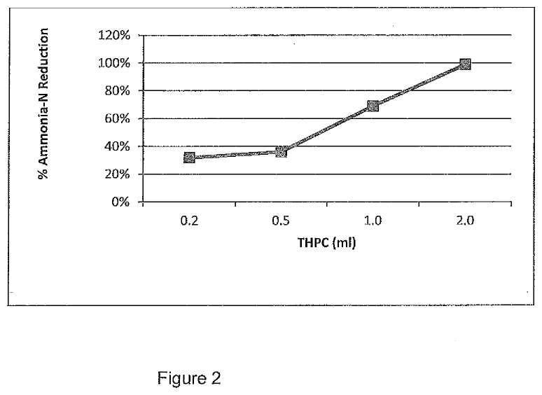

Ammonia concentration in the side stream from the dewatering process of anaerobically digested sludge may be measured following standard methods. To a known volume of the side stream, the dose required for THPC or THPS at a stoichiometric ratio to ammonia is added. Strong bases such as sodium hydroxide and potassium hydroxide, are commercially available in concentrated form, such as 40-50%, may be used with or without dilution, and may be added to the waste stream to elevate the pH. The pH may be adjusted to a range of 5-11, more preferably to a range of 5.5-10, most preferably to a range of 6-9. An aliquot of samples may be drawn at different time intervals, such as every 5 minutes, and ammonia concentration is measured after filtering the sample. As shown in FIG. 1, the reaction between ammonia and THPC is fast, reaching completion in less than 10 minutes. As expected, the rate of removal for ammonia in waste streams is dependent on the dosing rate of THPC as shown in FIG. 2.

The reaction between ammonia and THPC leads to the formation of insoluble compounds. Without wishing to be bound by any particular theory, it is believed that the reaction follows the mechanism of a modified Mannich reaction which leads to the formation of a short-chain polymer or oligomer.

In accordance with one or more embodiments, solid products may be either returned to the mainstream or optionally separated by centrifuge, decantation, or filtration. The recovered product may be dried and beneficially reused.

In accordance with one or more embodiments, the treatment products may be recovered as fertilizer. The side stream from anaerobically digested sludge contains phosphorous in addition to ammonia. The synergistic treatment of ammonia and phosphorous may be advantageously carried out in one single process using calcium hydroxide or magnesium hydroxide, either alone or in combination with a water-soluble base. Macronutrient analysis of the recovered product showed a similar level of nitrogen and phosphorous nutrients to other commercially recovered struvite products which are marketed as slow-release fertilizer (Table 1).

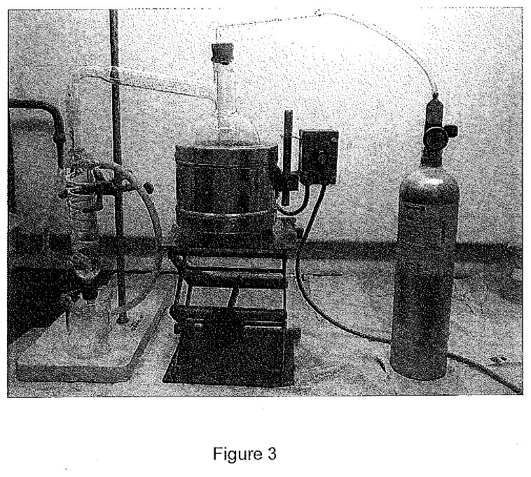

In accordance with one or more embodiments, a gas stream contaminated with ammonia may be passed through aqueous solutions of THP salts to afford the ammonia capture. In an experiment that simulates the air stripping of ammonia from liquid, a laboratory apparatus was set up as shown in FIG. 3. To the volumetric flask, 100 ml side stream is charged and pH is adjusted to 11 by adding sodium hydroxide solution. Compressed air is sparged through the side stream sample to drive off ammonia which is condensed and absorbed with 1% THPC solution. The pH of 1% THPC solution is monitored until the reaction is complete. Residual ammonia remaining in the side stream sample is measured and the removal rate is calculated.

In accordance with one or more aspects, the THP salts may be impregnated into solid substrates to form solid scavengers. The solid substrates may comprise any chemically compatible substrates, including but are not limited to, zeolite, perlite, activated carbon, glass fiber, silica, clay, synthetic fibers, and biobased substrates. Solid scavengers may be packed in a packed-bed scrubbing system. The ammonia-contaminated gas stream may be passed through the packed-bed system for treatment.

### Example 1

A side stream sample is taken from a wastewater treatment plant, and the ammonia concentration is measured to be 1800 mg/L as expressed by N—NH₃. To a 100 ml centrate sample under agitation, 1 ml of an 80% THPC compound (density 1.3 g/rip is added, followed by the addition of 10N NaOH (40%) to raise the pH to above 7. Allow the reaction to continue for 10 minutes. Solid is separated from liquid with a centrifuge, dried, and weighed.

### Example 2

10 ml 60% magnesium hydroxide slurry is combined with 60 ml 10N NaOH and completely dispersed under agitation. To 1000 ml centrate obtained from a wastewater treatment plant, 10 ml above mixture of the base are added, followed by addition of 10 ml THPC. The reaction mixture is continuously mixed for 30 minutes and allowed sufficient time to settle the solids. The supernatant is decanted and the remaining thickened solid is filtered through a 4.7-micron glass fiber filter and dried in an oven.

0.2 g recovered product is weighed and charged into 100 ml DI water, homogenized in a blender, and diluted to a final volume of 500 ml. The dispersed solid is analyzed for TKN and TP. The analysis for TKN and TP follows standard methods of SM 4500 N Org C and SM 4600 P E.

The analysis of bioavailable P follows AOAC method 963.03 in which 0.5 g of recovered solid is extracted with 50 ml ammonium citrate solution at 65° C. for one hour. The ammonium citrate solution is made by dissolving 37 g citrate acid in 150 ml DI water, followed by the addition of 40 ml concentrated ammonia (37%). As a control, a commercially available struvite product is obtained and analyzed by following the same procedure (Table 1).

TABLE 1
Macronutrients N-P in Recovered Products

| | Method of | Recovered | Commercially |
|---|---|---|---|
| | Analysis | Product | Recovered Struvite |
| TKN | SM4500N Org C | 6.70% | 5% |
| TP (as P₂O₅) | SM4500P E | 43% | 28% |
| Bioavailable P (as | AOAC 963.03 | 21.6% | 24.0% |
| P₂O₅) | | | |
| Ortho-P | SM4500P E | 11.5% | 10.5% |

While particular embodiments of the compositions and methods for the ammonia removal in liquid and gas streams have been shown and described, it will be appreciated by those skilled in the art that changes, and modifications may be made without departing from the inventions in their broader aspects and as outlined in the following claims.

What is claimed:

1. Compositions and methods for ammonia removal in contaminated liquid and gas streams, wherein said compositions comprise aqueous solutions of water-soluble tetrakis(hydroxymethyl)phosphonium (THP) salts of, including but not limited to, borate, carboxylates, halides, sulfate, and sulfonates; wherein said carboxylates include linear or branched carboxylate; wherein said halides include bromide, chloride, fluoride, and iodide; wherein said sulfonates comprise linear or branched, monomeric or polymeric sulfonates; wherein said methods comprise the selective and fast reaction between THP salts and ammonia at ambient conditions to form covalent compounds, wherein said covalent compounds may be insoluble compounds.

2. According to claim 1, a method for ammonia removal in liquid stream comprises dosing water-soluble tetrakis(hydroxymethyl)phosphonium (THP) salts into the contaminated streams, wherein said THP salts are available as concentrated or dilute aqueous solutions and are dosed at a molar ratio to ammonia in the range of 1:1 and 1:2; wherein said method comprises dosing pH elevating agents into the contaminated stream to maintain pH in the preferred range of 5-11, more preferably in the range of 5.5-10, most preferably in the range of 6-9, wherein said pH elevating agents comprise concentrated or dilute aqueous solutions of sodium hydroxide and potassium hydroxide and slurries of calcium hydroxide and magnesium hydroxide, or the combination of both types of pH elevating agents.

3. According to claim 1, a method for ammonia removal in gas stream comprise contacting ammonia contaminated gas stream with concentrated or dilute aqueous solutions of THP salts in a scrubber, wherein said THP salts selectively absorb and react with ammonia to form covalent compounds at ambient conditions; the method may further comprise passing contaminated gas streams through packed-bed of solid scavengers in a scrubber, wherein said solid scavengers are prepared by impregnating THP salts into solid substrates, wherein said solid substrates comprise chemically compatible substrates, including but not limited to, zeolite, perlite, activated carbon, glass fiber, silica, clay, synthetic fibers, and biobased substrates, wherein said solid scavenger selectively absorb and react with ammonia to form covalent compounds at ambient conditions.
